(19) United States
(12) Patent Application Publication
(10) Pub. No.: US 2021/0051764 A1
(43) Pub. Date: Feb. 18, 2021

(54) SPEAKER SYSTEM AND NETWORK CONTROL METHOD THEREOF

(71) Applicant: Tymphany Acoustic Technology Limited, TAIPEI CITY (TW)

(72) Inventors: Tao YUAN, TAIPEI CITY (TW); Wenjie TAN, TAIPEI CITY (TW)

(21) Appl. No.: 16/995,095

(22) Filed: Aug. 17, 2020

(30) Foreign Application Priority Data
Aug. 15, 2019 (CN) 201910751499.2

(51) Int. Cl. H04W 84/20; H04R 3/12; G06F 3/16

(52) U.S. Cl. CPC H04W 84/20; G06F 3/165; H04R 3/12

(57) ABSTRACT

A speaker system includes a master speaker and at least one slave speaker. The master speaker is connected to a control terminal. A network control method includes receiving a connecting instruction, and obtaining connecting information of a to-be-connected slave speaker according to the connecting instruction; building a self-network with the to-be-connected slave speaker according to the connecting information, to establish a speaker system which provides a connection and a communication between the master speaker and the slave speaker; determining a target speaker connected to a server, and obtaining a connecting address of the server by the target speaker; sending the connecting address of the server to a control terminal; and receiving a control instruction from the server to perform a corresponding control operation. The control terminal is connected to the server via the connecting address and generates the control instruction after being connected to the server via the connection address.

### CROSS REFERENCE TO RELATED APPLICATIONS

The present application claims priority to Chinese Patent Application No. CN 201910751499.2, which was filed on Aug. 15, 2019 the entire contents of which are hereby incorporated by reference.

### TECHNICAL FIELD

The application herein relates to the field of speaker systems, and in particular to a speaker system and a network control method thereof.

### BACKGROUND

With the progress of the times, the development of music is increasingly diverse, and the requirements from different users on speakers are also different. In some occasions, it is necessary to use multiple speakers to provide the sound effect, for example, the sound requirements in concerts, big villas or other large-scale sites.

The existing speaker devices are independent from each other in work. If there is a need to adjust parameters or implement other controls, there is a need to adjust parameters of the speakers to construct a speaker system by human setting via wiring connection, point-to-point connection or Lan connection. In this case, the number of the required speakers cannot be increased or decreased according to the user requirement. Additionally, for the speaker systems constructed in the above method, if it is needed to adjust internal parameters of each speaker, it is necessary for users to perform point-to-point control on each speaker of the speaker systems and, thus, the time consumption is considerable.

Therefore, for the existing speaker systems, the construction method is complex and the cost thereof is high, and the users cannot centrally control the speakers of the speaker systems, these disadvantages make user inconvenient.

### SUMMARY

The application provides a speaker system and a network control method thereof, which achieve network control of the speaker system flexibly and conveniently.

To achieve the above technical effect, the application provides a networking control method for a speaker system. The speaker system includes a master speaker and at least one slave speaker. The method is applied to the master speaker of the speaker system; the master speaker is connected to a control terminal; and the method includes receiving a connecting instruction, and obtaining a connecting information of a to-be-connected slave speaker according to the connecting instruction; building a self-network with the to-be-connected slave speaker according to the connecting information, to establish a speaker system which provides a connection and a communication between the master speaker and the slave speaker; determining a target speaker connected to a server, and obtaining a connecting address of the server by the target speaker; sending the connecting address of the server to a control terminal; and receiving a control instruction from the server to perform a corresponding control operation, the control terminal being connected to the server via the connecting address and generating the control instruction after being connected to the server via the connection address.

Optionally, the obtaining connecting information of a to-be-connected slave speaker according to the connecting instruction includes querying a connecting information list according to the connecting instruction, the connecting information list including at least one piece of connecting information; determining whether the connecting information is the connecting information of the to-be-connected slave speaker; and if yes, obtaining the connecting information of the to-be-connected slave speaker.

Optionally, the connecting information is device Identifier (ID) information and/or an Internet Protocol (IP) address of a Bluetooth or a Wireless Fidelity (WIFI) of the to-be-connected slave speaker.

Optionally, the building a self-network with the to-be-connected slave speaker according to the connecting information includes sending the connecting information to the control terminal; receiving a selecting instruction sent by the control terminal; and building the network with the corresponding slave speaker according to the selecting instruction.

Optionally, the building the network with the corresponding slave speaker according to the selecting instruction includes switching from an Access Point (AP) mode to a Static Timing Analysis (STA) mode; obtaining connecting information corresponding to the selecting instruction; and building the network with the corresponding slave speaker according to the connecting instruction.

Optionally, after determining a target speaker connected to a server, and obtaining a connecting address of the server by the target speaker, the method further includes setting the target speaker connected to the server into an AP mode, to connect to and communicate with the server via the target speaker.

Optionally, the control instruction includes an audio adjusting instruction; and the receiving a control instruction from the server to perform a corresponding control operation includes receiving the audio adjusting instruction from the server; and adjusting a default audio parameter according to the audio adjusting instruction.

Optionally, the method further includes receiving an audio adjusting instruction generated by an audio adjusting operation of a user; and uploading the audio adjusting instruction to the server, to forward the audio adjusting instruction to the slave speaker via other servers.

The application further provides a speaker system, including a master speaker and at least one slave speaker; the master speaker is connected to a control terminal; the master speaker includes a processor and a memory; and the processor is electrically connected to the memory; and the memory stores a computer program; and the processor executes the computer program stored in the memory for receiving a connecting instruction, and obtaining connecting information of a to-be-connected slave speaker according to the connecting instruction; building a self-network with the to-be-connected slave speaker according to the connecting information, to establish a speaker system which provides a connection and a communication between the master speaker and the slave speaker; determining a target speaker connected to a server, and obtaining a connecting address of the server by the target speaker; sending the connecting address of the server to the control terminal; and receiving a control instruction from the server to perform a corresponding control operation, the control terminal being connected to the server via the connecting address and generating the control instruction after being connected to the server via the connection address.

Optionally, the speaker system sets the target speaker connected to the server into the AP mode, to connect to and communicate with the server via the target speaker.

According to the speaker system and the network control method thereof in the application, the master speaker may implement the self-network with the slave speaker according to the connecting instruction generated by the control terminal or the master speaker, the manual point-to-point connection turns out to be unnecessary for each speaker in the speaker system, the speaker is connected more flexibly and conveniently, and the connecting cost is reduced; and moreover, by assisting the control terminal to connect to the server and centrally controlling the speaker system via the server, the speaker system may be controlled more conveniently.

### BRIEF DESCRIPTION OF FIGURES

FIG. 1 is an implementation flowchart of a network control method for a speaker system provided by an embodiment of the application.

FIG. 2 is an implementation flowchart of a connecting manner provided by an embodiment of the application.

FIG. 3 is an application scenario diagram of a connecting manner provided by an embodiment of the application.

FIG. 4 is another implementation flowchart of a connecting manner provided by an embodiment of the application.

FIG. 5 is a structural schematic diagram of a speaker system provided by an embodiment of the application.

FIG. 6 is a schematic diagram of a communicative interaction of a speaker system provided by an embodiment of the application.

### DETAILED DESCRIPTION

The technical solutions of the application are further described below in combination with the accompanying drawings and embodiments.

An embodiment of the application provides a network control method for a speaker system. The network control method is applied to the speaker system. The speaker system includes a master speaker and at least one slave speaker. The method is executed in the master speaker of the speaker system; and the master speaker is connected to a control terminal.

The control terminal may be a terminal with wireless transmission and control functions, for example, a mobile phone, a computer, a remote controller, etc. The master speaker, the slave speaker, the control terminal and the server can all be connected and communicated via a wired or wireless manner.

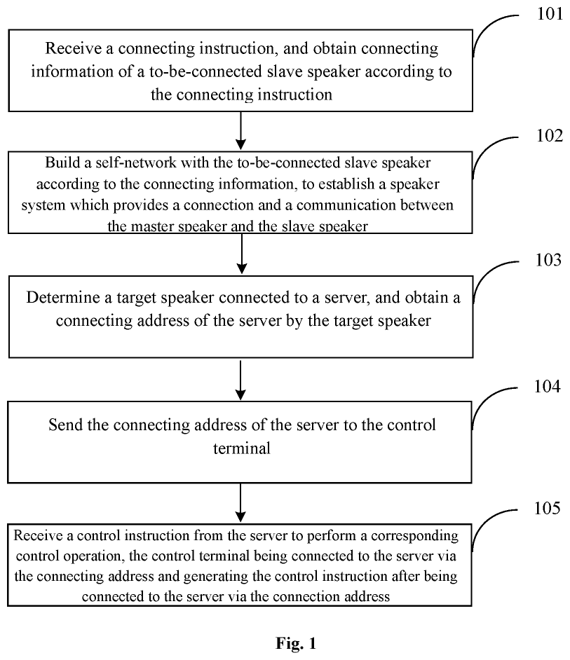

Referring to FIG. 1, an implementation flowchart of a network control method for a speaker system provided by an embodiment of the application is shown.

As shown in FIG. 1, the network control method for the speaker system includes the following steps:

101: Receive a connecting instruction, and obtain a connecting information of a to-be-connected slave speaker according to the connecting instruction.

The connecting instruction may be generated by the control terminal, and may also be generated by the master speaker. Specifically, the connecting instruction may be triggered by an operation of a user or generated based on a default condition. For example, the user clicks a connecting button on an operation interface, and the connecting button may trigger the connecting instruction.

Multiple pieces of connecting information may be provided to correspond to multiple slave speakers. The connecting information may be device ID information and/or an IP address of a Bluetooth or a WIFI of the to-be-connected slave speaker. In some embodiments, the connecting information may be a network address including the Bluetooth or the WIFI of the slave speaker, so that the master speaker may be connected to and communicated with the slave speaker via the connecting information of the slave speaker.

In addition, in some scenarios, if the speaker is connected via a wireless communication manner, the displayed connecting information of the slave speaker may be the connecting information of the slave speaker that is searched within a normal wireless communication range.

Certainly, the information format and the type specifically included in the connecting information may be determined as per an actual condition, provided that connection functions of the master speaker and the slave speaker can be implemented with the utilization of the connecting information.

102: Build a self-network with the to-be-connected slave speaker according to the connecting information, to establish a speaker system which provides a connection and a communication between the master speaker and the slave speaker.

Upon obtaining the connecting information, the slave speaker may be connected according to the connecting information.

In some embodiments, the master speaker may serve as a connecting node to be respectively connected to multiple slave speakers, thereby implementing a one-to-many connection manner.

For example, if the master speaker is the speaker A and the slave speaker includes the speaker B and the speaker C, then the speaker B and the speaker C are both directly connected to the speaker A to construct the speaker system.

In other some embodiments, the slave speaker connected to the master speaker may serve as a connecting node; then, the slave speaker serves as the master speaker to obtain other slave speakers, and the slave speakers are connected to the slave speaker, thereby implementing a multi-node connection manner.

For example, if the master speaker is the speaker A and the slave speaker includes the speaker B and the speaker C, after the speaker A is connected to the speaker B, the speaker B may serve as the master speaker and is connected to the speaker C to construct the speaker system.

Certainly, beyond that, a more complex communication network may be drawn out based on the above manner. The specific connecting manner is not defined by the application.

103: Determine a target speaker connected to a server, and obtain a connecting address of the server by the target speaker.

Upon the completion of connecting, the server may be connected to some speaker only due to hardware or an objective factor (for example, an overlarge distance). At this time, there is a need to determine the target speaker connected to the server in the speaker system.

Specifically, the target speaker may be connected to the server via a router, and which speaker is the target speaker may be determined by detecting a connection status between the speaker and the server, for example, it is detected that the connected IP address included in the speaker includes the IP address of the server.

In some embodiments, upon the determination of the target speaker, the target speaker may be set into an AP mode, so that the speaker system is only communicated with the server via the target speaker. In this way, the speaker system may be connected to the server via the unique target speaker without reliance on the maximum connecting number of routers, and thus the connecting number of speakers and the serviceable range of the speaker system are expanded.

In some embodiments, upon the determination of the target speaker, an obtaining instruction generated for the connecting address of the server may be sent to the server via a connection relationship between the target speaker and the server. The server may send the connecting address to the master speaker of the speaker system after receiving the obtaining instruction.

The connecting address may be a network address of the server, so that the control terminal is connected to the server via an Internet.

104: Send the connecting address of the server to the control terminal.

The connecting address is sent to the control terminal via a connection relationship between the master speaker and the control terminal. At this time, the control terminal may be connected to the server via the connecting address.

Specifically, the server may be connected to a router and then directly connected to the server by the use of the connecting address, or may be accessed to the Internet via a wireless network (such as a 4G wireless network) and then connected to the server by the use of the connecting address.

It may be understood that a variety of connecting manners may be provided actually and the application is not limited thereto.

105: Receive a control instruction from the server to perform a corresponding control operation, the control terminal being connected to the server via the connecting address and generating the control instruction after being connected to the server via the connection address.

After the control terminal is connected to the server, the server may receive, by means of connecting, the control instruction sent by the control terminal for controlling an action of the speaker system.

After determining that the control instruction is the control instruction for controlling the action of the speaker system, the server may send the control instruction to each speaker (including the master speaker and the slave speaker) in the speaker system via the target speaker. Each speaker may execute a corresponding control operation according to the control instruction.

The control instruction may be an audio adjusting instruction, a functional setting instruction, other instructions associated with functional implementation of the speaker, etc.

In some embodiments, the control instruction includes an audio adjusting instruction.

The step of receiving a control instruction from the server to execute a corresponding control operation includes: receiving the audio adjusting instruction from the server; and adjusting a default audio parameter according to the audio adjusting instruction.

The audio adjusting instruction may be used to control the speaker to execute an audio adjusting action, for example, to adjust a tone, a volume and other parameters of an audio in the speaker.

Each speaker may make an audio adjustment according to the received audio adjusting instruction, so that audios of speakers in the speaker system are centrally controlled and adjusted by the control terminal or the server, and convenience is provided for a user to control the speaker system centrally.

In other some embodiments, the master speaker may further receive an audio adjusting instruction generated by an audio adjusting operation of the user; and upload the audio adjusting instruction to the server, to forward the audio adjusting instruction to the slave speaker via other servers.

The audio adjusting operation may be an operation of the user in the control terminal, may also be an audio adjusting operation of the user for the audio in the master speaker, and may further be an audio adjusting operation of the user for the audio in the slave speaker.

Upon the completion of the operation, the corresponding audio adjusting instruction may be generated and the audio adjusting instruction is uploaded to the server. The server sends the audio adjusting instruction to other slave speakers, so that the other slave speakers may be synchronous to the master speaker in audio adjusting operation according to the audio adjusting instruction. Therefore, the user does not need to adjust audios of different speakers and a large amount of operation time is saved.

Therefore, according to the connecting method of the speaker system in the application, the master speaker may implement the self-network with the slave speaker according to the connecting instruction generated by the control terminal or the master speaker, the manual point-to-point connection turns out to be unnecessary for each speaker in the speaker system, the speaker system is connected more flexibly and conveniently, and the connecting cost is reduced; and moreover, by assisting the control terminal to connect to the server and centrally controlling the speaker system via the server, the speaker system may be controlled more conveniently.

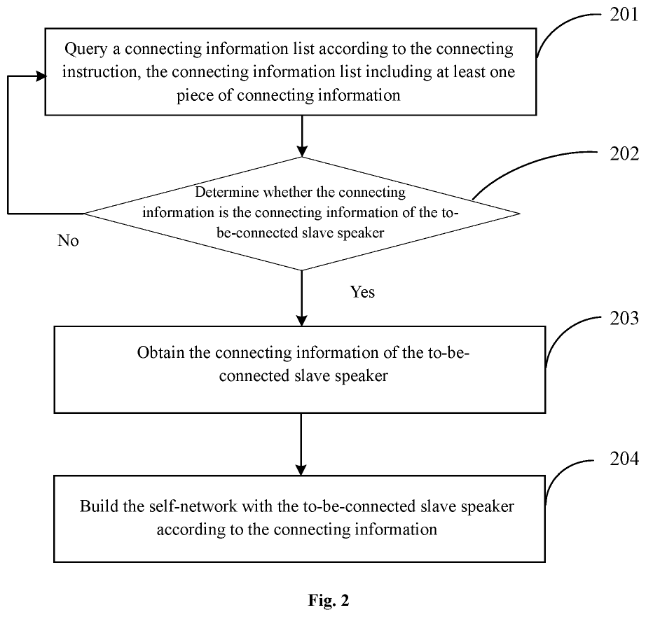

Referring to FIG. 2, an implementation flowchart of a connecting manner provided by an embodiment of the application is shown.

As shown in FIG. 2, the step of obtaining connecting information of a to-be-connected slave speaker according to the connecting instruction includes:

201: Query a connecting information list according to the connecting instruction, the connecting information list including at least one piece of connecting information.

The connecting information list may be obtained from an attribute of the master speaker, and then the connecting information is sent to the control terminal and displayed in an operation interface of the control terminal, thus facilitating viewing of the user. Certainly, the connecting information list may also not be displayed by the control terminal but use a manner of automatically executing a program to execute a next step of operation.

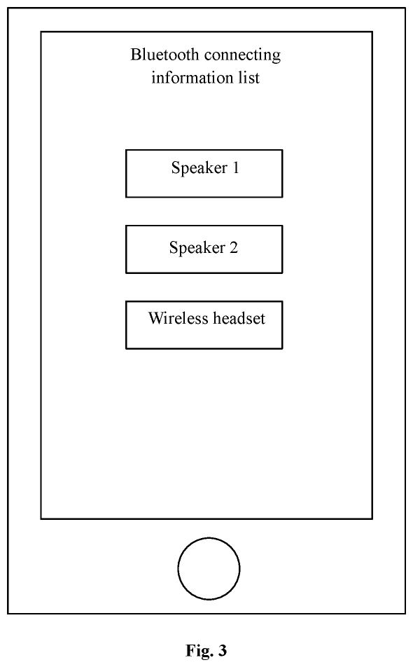

In combination with FIG. 3, an application scenario of a connecting manner is shown.

In the application scenario, the operation interface of the control terminal is shown. The operation interface displays a Bluetooth connecting information list of each Bluetooth device associated with the master speaker.

The Bluetooth connecting information list includes three pieces of connecting information, including the “speaker 1”, the “speaker 2” and the “wireless headset”.

202: Determine whether the connecting information is the connecting information of the to-be-connected slave speaker.

The determination on whether the connecting information is the connecting information of the to-be-connected slave speaker may be confirmed from the device ID information or the IP information of the connecting information, for example, the device ID address includes a data characteristic (such as a type of the speaker), or a default IP address.

It may be understood that the specific determination process may be determined according to an actual condition.

Upon the determination that some piece of connecting information is the connecting information of the to-be-connected slave speaker, the connecting information may be obtained; or otherwise, the connecting information is omitted.

In some embodiments, the control terminal may receive a selecting operation (such as point contact) of the user for a displayed connecting information icon, triggers via the selecting operation to generate a selecting instruction and sends the selecting instruction to the master speaker. Upon the reception of the selecting instruction from the control terminal, the master speaker may obtain connecting information corresponding to the selecting instruction.

203: Obtain the connecting information of the to-be-connected slave speaker.

In some embodiments, the master speaker may obtain the corresponding connecting information based on the selecting instruction generated by the user operation.

After the connecting information is obtained completely, a next piece of connecting information in the connecting information list may be determined automatically, or a selecting instruction generated by a next user operation is received.

204: Build the self-network with the to-be-connected slave speaker according to the connecting information.

The connecting process may refer to the description in FIG. 1 and will not be repeated herein.

As can be seen, based on the connecting information list and by determining and matching the connecting information in the list, connecting information of the to-be-connected slave speaker may be extracted selectively, the wrong connection to other devices may be prevented, and the connecting process is more specific.

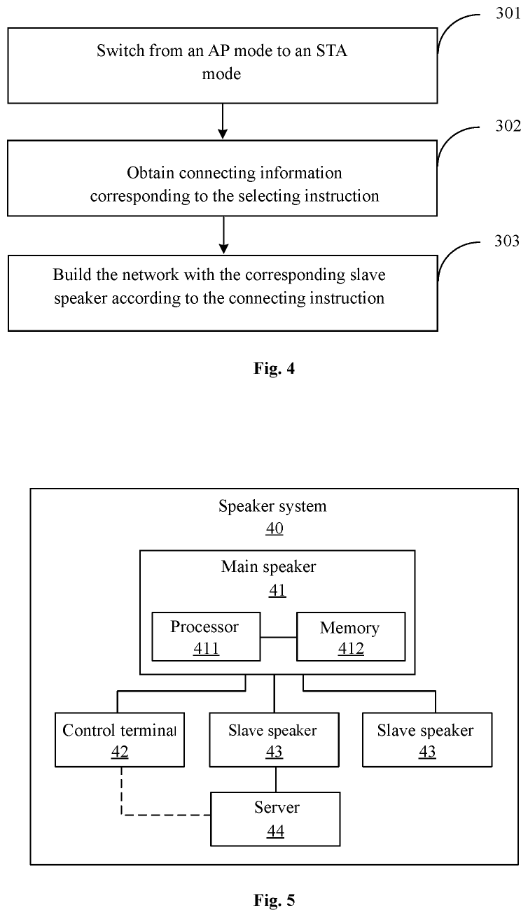

Referring to FIG. 4, another implementation flowchart of a connecting manner provided by an embodiment of the application is shown.

As shown in FIG. 4, in order that the master speaker may perform the connecting operation actively, the step of building the network with the corresponding slave speaker according to the selecting instruction includes:

301: Switch from an AP mode to an STA mode.

In the STA mode, the master speaker exists as the terminal, and may provide a control authority for the terminal to complete the connecting action.

302: Obtain connecting information corresponding to the selecting instruction.

The selecting instruction is generated by the control terminal by receiving the selecting operation of the user for the displayed connecting information icon. With the utilization of the selecting instruction, connecting information of a slave speaker to which the user desires to connect may be obtained.

303: Build the network with the corresponding slave speaker according to the connecting information.

As can be seen, by switching the working mode of the master speaker, the control authority of the terminal may be provided for the master speaker, so that the master speaker may be connected based on the default rule without the control of the control terminal to facilitate the connecting operation of the user.

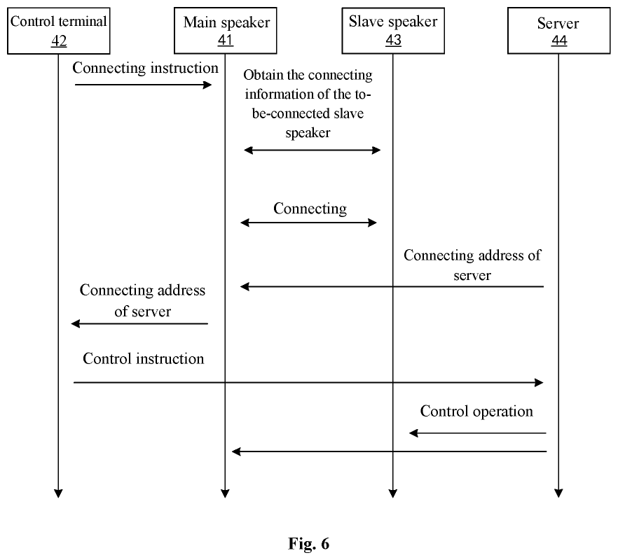

Referring to FIGS. 5-6, a structure and a communicative interaction manner of a speaker system provided by an embodiment of application are shown.

As shown in FIGS. 5-6, the speaker system 40 includes a master speaker 41 and at least one slave speaker 43. The master speaker 41 is connected to a control terminal 42. The master speaker 41 includes a processor 411 and a memory 412, and the processor 411 is electrically connected to the memory 412.

The memory 412 stores a computer program; and the processor 411 executes the computer program stored in the memory 412 for the following steps:

Receive a connecting instruction, and obtain connecting information of a to-be-connected slave speaker 43 according to the connecting instruction.

Build a self-network with the to-be-connected slave speaker 43 according to the connecting information, to establish a speaker system 40, which provides a connection and a communication between the master speaker and the slave speaker.

Determine a target speaker connected to a server 44, and obtain a connecting address of the server 44 by the target speaker.

Send the connecting address of the server 44 to the control terminal 42.

Receive a control instruction from the server 44 to perform a corresponding control operation, the control terminal 42 being connected to the server 44 via the connecting address and generating the control instruction after being connected to the server 44 via the connection address.

In some embodiments, the processor 411 is specifically configured to query a connecting information list according to the connecting instruction, the connecting information list including at least one piece of connecting information; determine whether the connecting information is the connecting information of the to-be-connected slave speaker 43; and if yes, obtain the connecting information of the to-be-connected slave speaker 43.

In some embodiments, the processor 411 is specifically configured to send the connecting information to the control terminal 42; receive a selecting instruction sent by the control terminal 42; and build the network with the corresponding slave speaker 43 according to the selecting instruction.

In some embodiments, the processor 411 is specifically configured to switch from an AP mode to an STA mode; obtain connecting information corresponding to the selecting instruction; and build the network with the corresponding slave speaker 43 according to the connecting instruction.

In some embodiments, the processor 411 is specifically configured to set the target speaker connected to the server 44 into the AP mode, to connect to and communicate with the server 44 via the target speaker.

In some embodiments, the processor 411 is specifically configured to receive an audio adjusting instruction from the server 44; and adjust a default audio parameter according to the audio adjusting instruction.

In some embodiments, the processor 411 is specifically configured to receive an audio adjusting instruction generated by an audio adjusting operation of a user; and upload the audio adjusting instruction to the server 44, to forward the audio adjusting instruction to the slave speaker 43 via other servers 44.

The connecting instruction may be generated by the control terminal 42, and may also be generated by the master speaker 41. Specifically, the connecting instruction may be triggered by an operation of a user or generated based on a default condition. For example, the user clicks a connecting button on an operation interface, and the connecting button may trigger the connecting instruction.

Multiple pieces of connecting information may be provided to correspond to multiple slave speakers 43. The connecting information may be device ID information and/or an IP address of a Bluetooth or a WIFI of the to-be-connected slave speaker 43. In some embodiments, the connecting information may be a network address including the Bluetooth or the WIFI of the slave speaker 43, so that the master speaker 41 may be connected to and communicated with the slave speaker 43 via the connecting information of the slave speaker 43.

Upon obtaining the connecting information, the slave speaker 43 may be connected according to the connecting information.

In some embodiments, the master speaker 41 may serve as a connecting node to be respectively connected to multiple slave speaker 43, thereby implementing a one-to-many connection manner.

In other some embodiments, the slave speaker 43 connected to the master speaker 41 may serve as a connecting node; then, the slave speaker 43 serves as the master speaker 41 to obtain other slave speaker 43, and the other slave speakers are connected to the slave speaker 43, thereby implementing a multi-node connection manner.

Upon the completion of connecting, the server 44 may be connected to some speaker only due to hardware or an objective factor (for example, an overlarge distance). At this time, there is a need to determine the target speaker connected to the server 44 in the speaker system 40.

In some embodiments, upon the determination of the target speaker, the target speaker may be set into an AP mode, so that the speaker system 40 is only communicated with the server 44 via the target speaker. In this way, the speaker system 40 may be connected to the server 44 via the unique target speaker without reliance on the maximum connecting number of routers, and thus the connecting number of speakers and the serviceable range of the speaker system 40 are expanded.

In some embodiments, upon the determination of the target speaker, an obtaining instruction generated for the connecting address of the server 44 may be sent to the server 44 via a connection relationship between the target speaker and the server 44. The server 44 may send the connecting address to the master speaker 41 of the speaker system 40 after receiving the obtaining instruction.

The connecting address may be a network address of the server 44, so that the control terminal 42 is connected to the server 44 via an Internet.

The connecting address is sent to the control terminal 42 via a connection relationship between the master speaker 41 and the control terminal 42. At this time, the control terminal 42 may be connected to the server 44 via the connecting address.

After the control terminal 42 is connected to the server 44, the server 44 may receive, by means of connecting, the control instruction sent by the control terminal 42 for controlling an action of the speaker system 40.

After determining that the control instruction is the control instruction for controlling the action of the speaker system 40, the server 44 may send the control instruction to each speaker (including the master speaker 41 and the slave speaker 43) in the speaker system 40 via the target speaker. Each speaker may execute a corresponding control operation according to the control instruction.

The control instruction may be an audio adjusting instruction, a functional setting instruction, other instructions associated with functional implementation of the speaker, etc.

Therefore, according to the speaker system in the application, the master speaker may implement the self-network with the slave speaker according to the connecting instruction generated by the control terminal or the master speaker, the manual point-to-point connection turns out to be unnecessary for each speaker in the speaker system, the speaker system is connected more flexibly and conveniently, and the networking cost is reduced; and moreover, by assisting the control terminal to connect to the server and centrally controlling the speaker system via the server, the speaker system may be controlled more conveniently.

In this embodiment of the application, the speaker system has a concept same as the network control method for the speaker system in the foregoing embodiment. Steps of any method provided in the embodiment of the network control method for the speaker system may be operated on the speaker system, and the specific implementation process is detailed in the embodiment of network control method for the speaker system. Furthermore, any combination may be used to form an optional embodiment of the application, which will not be repeated herein.

In some embodiments, this embodiment of the application further provides a storage medium; multiple instructions are stored in the storage medium; and the instruction is applied to being loaded by a processor to execute the network control method for the speaker system, for example:

Receive a connecting instruction, and obtain connecting information of a to-be-connected slave speaker according to the connecting instruction.

Build a self-network with the to-be-connected slave speaker according to the connecting information, to establish a speaker system which provides a connection and a communication between the master speaker and the slave speaker.

Determine a target speaker connected to a server, and obtain a connecting address of the server by the target speaker.

Send the connecting address of the server to a control terminal.

Receive a control instruction from the server to perform a corresponding control operation, the control terminal being connected to the server via the connecting address and generating the control instruction after being connected to the server via the connection address.

Those of ordinary skill in the art may know that all or part of the steps of the methods in the above embodiments may be implemented by instructing related hardware through a program, the program may be stored in a computer-readable storage medium, and the storage medium may include: a Read-Only Memory (ROM), a Random Access Memory (RAM), a magnetic disk or an optical disc.

What is claimed is:

1. A network control method for a speaker system, wherein the speaker system comprises a master speaker and a slave speaker, the method is applied to the master speaker of the speaker system, the master speaker is connected to a control terminal, and the method comprises:
receiving a connecting instruction;
obtaining connecting information of a to-be-connected slave speaker according to the connecting instruction;
building a self-network with the to-be-connected slave speaker according to the connecting information, to establish a speaker system which provides a connection and a communication between the master speaker and the slave speaker;
determining a target speaker connected to a server;
obtaining a connecting address of the server by the target speaker;
sending the connecting address of the server to the control terminal; and
receiving a control instruction from the server to perform a corresponding control operation, wherein the control terminal is connected to the server via the connecting address and generates the control instruction after being connected to the server via the connecting address.

2. The network control method for the speaker system according to claim 1, wherein the obtaining connecting information of a to-be-connected slave speaker according to the connecting instruction comprises:
querying a connecting information list according to the connecting instruction, the connecting information list comprising at least one piece of connecting information;
determining whether the connecting information is the connecting information of the to-be-connected slave speaker; and
if the connecting information is the connecting information of the to-be-connected slave speaker, then obtaining the connecting information of the to-be-connected slave speaker.

3. The networking control method for the speaker system according to claim 1, wherein the connecting information is device Identifier (ID) information, an Internet Protocol (IP) address of a Bluetooth or a Wireless Fidelity (WIFI) of the to-be-connected slave speaker.

4. The network control method for the speaker system according to claim 1, wherein the building a self-network with the to-be-connected slave speaker according to the connecting information comprises:
sending the connecting information to the control terminal;
receiving a selecting instruction sent by the control terminal; and
building the network with the corresponding slave speaker according to the selecting instruction.

5. The networking control method for the speaker system according to claim 4, wherein the building the network with the corresponding slave speaker according to the selecting instruction comprises:
switching from an Access Point (AP) mode to a Static Timing Analysis (STA) mode;
obtaining connecting information corresponding to the selecting instruction; and
building the network with the corresponding slave speaker according to the connecting instruction.

6. The network control method for the speaker system according to claim 1, further comprising, after said determining the target speaker connected to the server and said obtaining the connecting address of the server by the target speaker, setting the target speaker connected to the server into an AP mode, to connect to and communicate with the server via the target speaker.

7. The network control method for the speaker system according to claim 1, wherein the control instruction comprises an audio adjusting instruction; and
wherein the receiving the control instruction from the server to perform the corresponding control operation comprises:
receiving the audio adjusting instruction from the server; and
adjusting a default audio parameter according to the audio adjusting instruction.

8. The network control method for the speaker system according to claim 1, further comprising:
receiving an audio adjusting instruction generated by an audio adjusting operation of a user; and
uploading the audio adjusting instruction to the server, to forward the audio adjusting instruction to the slave speaker via other servers.

9. A speaker system, comprising
a control terminal;
a master speaker connected to the control terminal, the master speaker comprising:
a memory; and
a processor electrically connected to the memory; and
a slave speaker,
wherein the memory stores a computer program and the processor executes the computer program stored in the memory for performing:
receiving a connecting instruction;
obtaining connecting information of a to-be-connected slave speaker according to the connecting instruction;
building a self-network with the to-be-connected slave speaker according to the connecting information, such that the speaker system provides a connection and a communication between the master speaker and the slave speaker;
determining a target speaker connected to a server;
obtaining a connecting address of the server by the target speaker;
sending the connecting address of the server to the control terminal; and
receiving a control instruction from the server to perform a corresponding control operation, wherein the control terminal is connected to the server via the connecting address and generates the control instruction after being connected to the server via the connecting address.

10. The speaker system according to claim 9, wherein the speaker system sets the target speaker connected to the server into an Access Point (AP mode), to connect to and communicate with the server via the target speaker.
